(19) United States
(12) Patent Application Publication
(10) Pub. No.: US 2017/0246809 A1
(43) Pub. Date: Aug. 31, 2017

(54) QUALITY CERTIFICATION METHOD FOR AN ADDITIVE MANUFACTURING PROCESS

(71) Applicant: University of Louisville Research Foundation, Inc., Louisville, KY (US)

(72) Inventor: Thomas L. Starr, Louisville, KY (US)

(21) Appl. No.: 14/742,023

(22) Filed: Jun. 17, 2015

Related U.S. Application Data
(60) Provisional application No. 62/013,341, filed on Jun. 17, 2014.

(51) Int. Cl. B29C 67/00; G05B 15/02

(52) U.S. Cl. CPC B29C 67/0088; G05B 15/02; B33Y 50/02

(57) ABSTRACT

In a quality certification method, a digital, three-dimensional Quality Certificate (3DQC) is created by the manufacturer and is delivered to the customer along with the manufactured part. The data in the 3DQC can be viewed using a three-dimensional rendering system, such that the customer that review and confirm that certain process monitor values were within specification during the entire manufacturing process.

### CROSS-REFERENCE TO RELATED APPLICATIONS

The present application claims priority to U.S. Patent Application Ser. No. 62/013,341 filed on Jun. 17, 2014.

### BACKGROUND OF THE INVENTION

The present invention is related to quality certification methods for additive manufacturing processes.

In additive manufacturing (also known as “three-dimensional printing” or “3D printing”) of products for aerospace, medical, or other critical applications, the quality of each manufactured part must be “certified” before it can be used. However, current quality certification methods were designed for traditional, high part count manufacturing, and thus place a cost burden on additive manufacturing and create a barrier against adopting additive manufacturing for short-run and custom manufacturing.

Some aspects of standard manufacturing quality certification methods are transferable to additive manufacturing processes. For example, the process of qualifying a batch of material for use in an additive manufacturing process is similar to that for other processes, such as die casting or injection molding. The input materials must have certain characteristics, and these characteristics can be tested for each batch of material or certified by a vendor. Metal powders for powder metallurgy processing and for selective laser melting will have different physical characteristics, but these physical characteristics can be specified. In general, the processes for specifying and qualifying input materials for standard and additive manufacturing processes will be similar. Quality certification of post-manufacturing processes also may be similar for additive manufacturing and standard manufacturing processes. For example, post-build heat treatments for batches of titanium parts manufactured by additive manufacturing or standard manufacturing processes may require different temperature schedules, but the methods for certifying the post-manufacture quality of these parts will be similar.

However, other aspects of standard manufacturing quality certification methods do not translate well to additive manufacturing processes.

For example, the use of “witness” coupons is common in qualifying injection-molded or cast parts. A certain number of such coupons are fabricated at the same time as the parts. Destructive testing of these coupons ensures that their properties are consistent, implying that the part properties are as-specified. The cost of this additional fabrication and testing may not be onerous for production of large numbers of identical parts. However, additive manufacturing processes generally are used for smaller numbers of identical parts and even custom, one-of-a-kind parts. The cost of producing and testing witness coupons can be greater than that for producing the parts themselves, a cost-barrier that inhibits adoption of additive manufacturing processes.

For another example, process monitoring can be used to certify that a process is running consistently and within specifications for a particular material and process. For instance, in injection molding, a set of temperature, pressure, and timing parameters can be determined during development runs, using part testing to establish the range of parameter values that produce “good” parts. During the production run, these parameters are monitored, and maintenance of these parameters implies consistent properties for the parts. The relative cost of parameter development is not large for runs of large numbers of identical parts. Again, for short-run or custom manufacturing, such costs are very large and create a barrier against adopting additive manufacturing processes.

Neither the witness-coupon method nor the process monitoring method is well suited to additive manufacturing quality certification. The unique advantages of additive manufacturing processes, including geometric complexity and low first-part cost, cannot be realized if the chosen quality certification method adds considerable cost to the manufacturing process. Thus, there remains a need for a new and improved quality certification method for an additive manufacturing process.

### SUMMARY OF THE INVENTION

The present invention is a quality certification method for an additive manufacturing process, a quality certification method that takes advantage of the unique characteristics of layerwise additive manufacturing processes. Specifically, in the quality certification method of the present invention, a digital, three-dimensional Quality Certificate (3DQC) is created by the manufacturer and is delivered to the customer along with the manufactured part in order to assure the customer that certain process monitor values were within specification during the entire manufacturing process.

A 3DQC is commonly created in two steps. First, a three-dimensional binary template is created from the shape of the part, along with information about how the part was oriented and sliced for the manufacturing process. Second, the three-dimensional binary template is used to index data, layerwise, from run-time process monitors to create three-dimensional data structures that are congruent with the template and with each other. The data stored in these data structures provides a record of the process conditions during manufacture of each volume element of the part. Process monitors may provide data that measure slowly changing conditions (e.g., build surface temperature) within the machine or that measure local conditions (e.g., peak temperature during laser scanning) point-wise within a layer. Once indexing is complete, the 3DQC is stored and labeled as a record of the manufacturing process for a specific part. The data in the 3DQC can be viewed using any one of several three-dimensional rendering systems that have been developed for viewing and analyzing other three-dimensional data records, such as a computerized topography (CT) or magnetic resonance imaging (MRI) scan data.

### DESCRIPTION OF THE DRAWINGS

FIG. 1 is a flow chart of an exemplary implementation of the method of the present invention;

FIG. 1A is a flow chart of an exemplary implementation of the step of creating a template for the 3DQC in the method of the present invention;

FIG. 1B is a flow chart of an exemplary implementation of the step of indexing continuous monitor data (i.e., build surface temperature) to the template in the method of the present invention;

FIG. 1C is a flow chart of exemplary implementation of the step of indexing layerwise monitor data (i.e., peak temperatures) to the template in the method of the present invention;

FIG. 2 is a perspective view of a shaded rendering (or model) of a part to be manufactured;

FIG. 3 is a plan view of a layer of the part of FIG. 2;

FIG. 4 is a binary image of the layer of FIG. 3;

FIG. 5 is an image of the peak temperature measured for each pixel in the thermal images of the layer of FIG. 3;

FIG. 6 is a gray-scale image of build surface temperature for a vertical cut through the part as oriented in FIG. 2; and

FIG. 7 is a gray-scale image of peak temperature for a vertical cut through the part as oriented in FIG. 2.

### DETAILED DESCRIPTION OF THE INVENTION

The present invention is a quality certification method for an additive manufacturing process, a quality certification method that takes advantage of the unique characteristics of layerwise additive manufacturing processes.

The quality certification method of the present invention uses run-time process monitoring to create a digital three-dimensional Quality Certificate (3DQC) for a manufactured part. Such a 3DQC is a unique, high-definition record of the manufacturing process for the part, and the 3DQC is delivered to the customer along with the manufactured part in order to assure the customer that certain process monitor values were within specification during the entire manufacturing process.

The generation of such a record of the manufacturing process for the part is possible because the quality certification method of the present invention allows for observation of every volume element of the three-dimensional part as it is being formed. Interior volumes of a part, which are unobservable in molding, machining, and casting processes, can be monitored and inspected, before a subsequent layer is added. Such monitoring and creation of the 3DQC, which is indexed to the part geometry, ensures that each volume element of the part meets quality specifications.

In addition, the quality certification method of the present invention enhances the use of non-destructive evaluation (NDE) and advanced process control techniques. By relating process deviations to specific regions of a part, the use of post-build part evaluation can be optimized by focusing on these areas. The indexing methods used to create a 3DQC may also be used in advanced process control techniques, where the optimum process parameters depend on the geometry of the layers and the process history of previous layers.

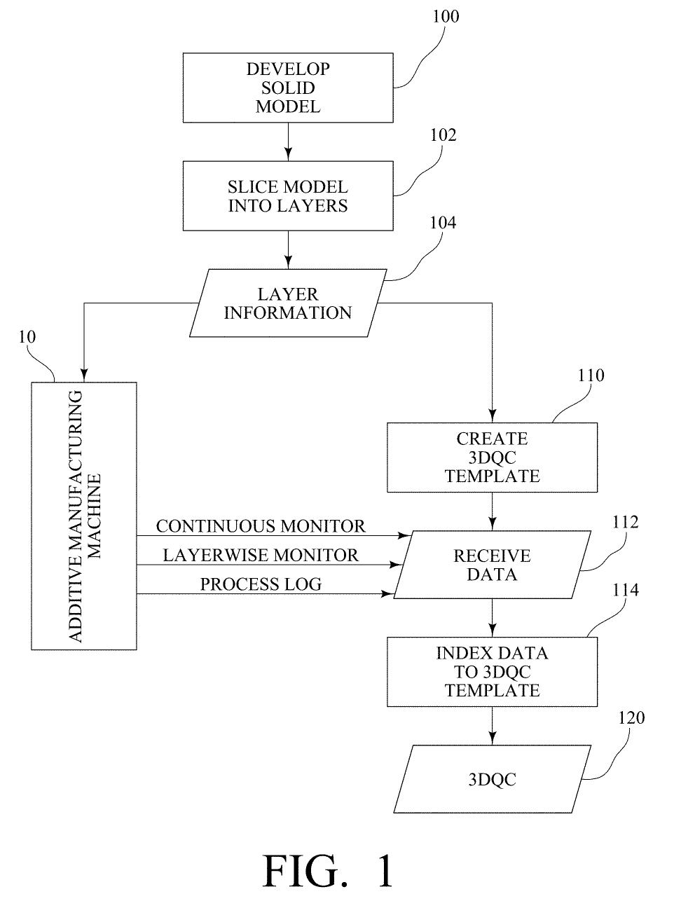

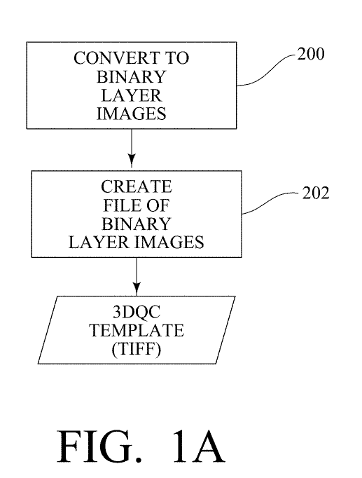

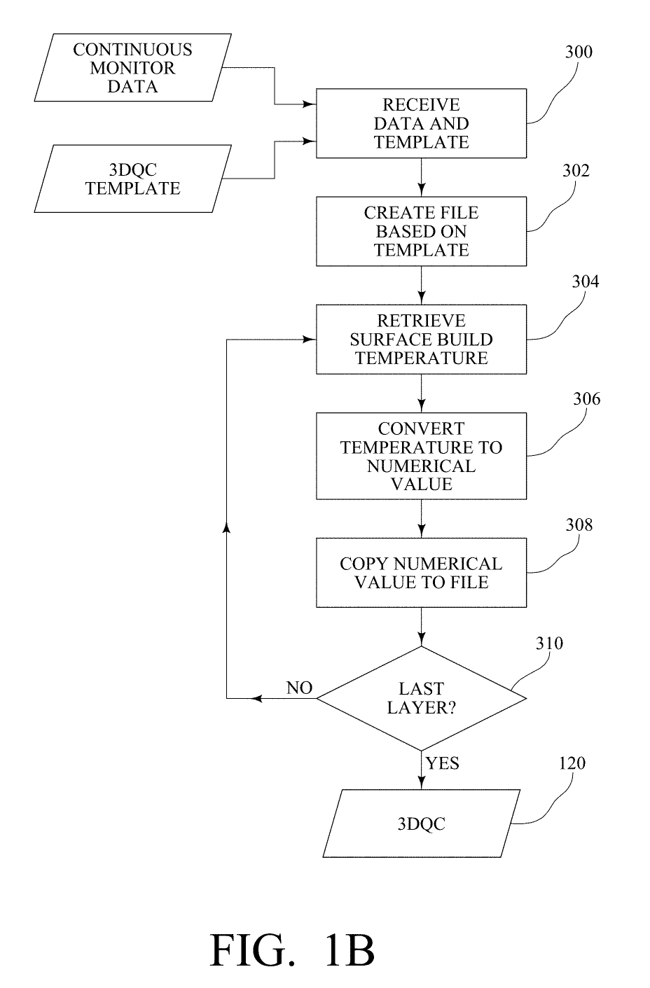

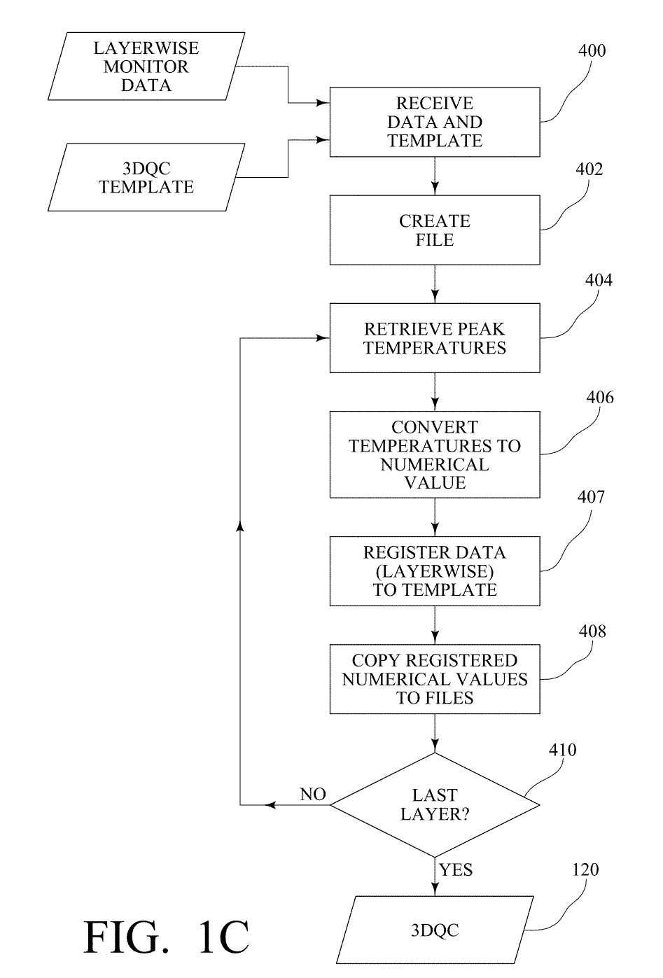

Referring now to FIG. 1, in an additive manufacturing process, a solid model of a part to be manufactured is developed, as indicated by block 100 in FIG. 1. This solid model is then sliced into layers of a specified thickness, as indicated by block 102 of FIG. 1, and the resultant layer information is in a data file (such as a Common Layer Interface (CLI) file), as indicated by output 104 in FIG. 1, that is sent to the additive manufacturing machine 10 and used for manufacture of the part.

At the same time as the data file is sent to the additive manufacturing machine 10, an exemplary quality certification method for the additive manufacturing process in accordance with the present invention commences with the digitization and stacking of the layer information to create a template for a 3DQC, as indicated by block 110 in FIG. 1. In this regard, and as will become clearer from the discussion that follows and the example presented below, the template is created using the same layer information that is sent to the additive manufacturing machine 10 and used for manufacture of the part.

Referring still to FIG. 1, during the manufacturing process, certain parameters are continuously monitored, and certain data is received for the 3DQC, as indicated by input 112 in FIG. 1. For example, such data might include: (a) continuous monitor data (which is often slowly changing during the manufacturing process), such as oxygen level or build surface temperature, which is received at regular or irregular time intervals and stored with a time-stamp or some indicator of which layer is being built when a data point is collected; (b) layerwise monitor data, such as infrared or visible camera images, that is received as two-dimensional images of a particular layer of the part during its manufacture; (c) process log data, such as the start and finish time for each layer, the sequence of formation for each volume element within the layer (i.e., scan pattern), and process control parameters. As the data is received and stored, it is indexed to the template as part of the creation of the 3DQC, as indicated by block 114 in FIG. 1.

For example, for continuous monitor data, the value stored in the template is based on a layer index from the machine or a time-stamp relating the value to a particular layer in the template.

For another example, for layerwise monitor data, the value stored in the template is based on the two-dimensional location within the layer and the location of that layer in the template. For instance, indexing of layerwise monitor data may involve transformation of the image produced by a camera to the layer coordinate system represented by the template in order to determine the relationship between a pixel value of the image produced by the camera and the three-dimensional location in the template. Layerwise monitor data may be either an instantaneous record of the layer manufacturing process or a combined record that is composed of a series of instantaneous records taken during manufacture of a particular layer.

Such indexing of monitor data to the template may be performed in real-time during the manufacturing process or after completion of the build using stored monitor data, and further description of such indexing of the monitor data to the template is provided with respect to the example presented below.

Once the manufacture of the part is complete and indexing of the collected data is also complete, the resulting 3DQC for each monitor is a data file, as indicated by output 120 in FIG. 1, which is stored as a record of the manufacturing process for the part. The data in each such 3DQC can be subsequently viewed and compared using any one of several three-dimensional rendering systems that have been developed for viewing and analyzing other three-dimensional data records, such as a computerized topography (CT) or magnetic resonance imaging (MRI) scan data.

### Example

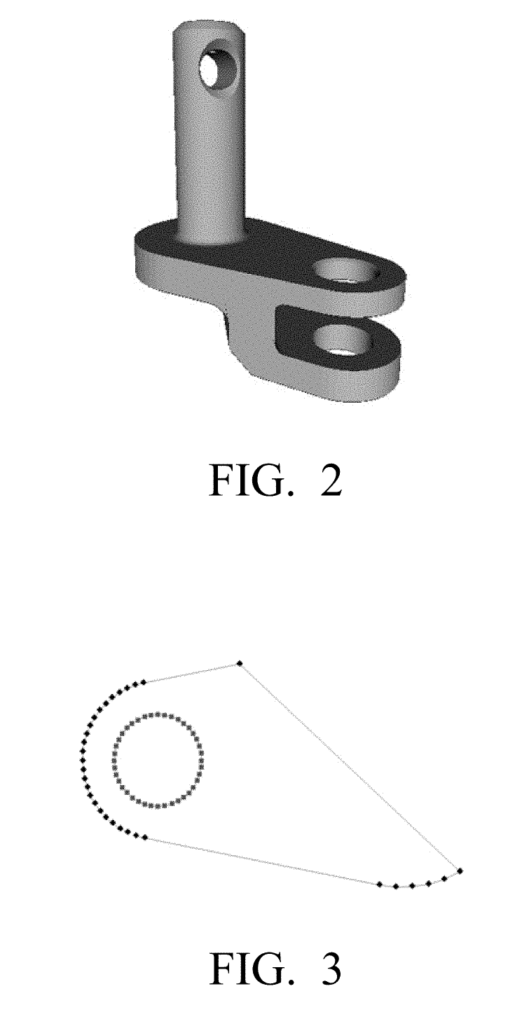

FIG. 2 is a shaded rendering (or model) of a part to be manufactured, which has been generated from a stereolithography (STL) file. Such a rendering or model, whether in an STL file or another file format, is the typical starting point for any additive manufacturing process. As described above, the model is then sliced into layers of a specified thickness, as indicated by block 102 of FIG. 1. In this regard, many different orientations can be used for slicing and building a part. Selection of the build orientation is typically performed by the machine operator just prior to starting the manufacturing process. The layer thickness is often specified by the machine manufacturer and may depend on the material used. In this case, the part is to be built in a substantially vertical orientation, as shown in FIG. 2, and using 0.030-mm layer thickness. That being said, the machine operator may choose to build the part in a different orientation, for example, 45° from the substantially vertical orientation shown in FIG. 2. For a metal powder laser melting, such an orientation would minimize the amount of support material required.

As described above, after slicing the part in the selected orientation, layer information is stored in a Common Layer Interface (CLI) file (or other suitable file format), as indicated by output 104 in FIG. 1. This file format describes the geometry of each layer by specifying coordinates of vertex points (to be connected by straight lines) and a direction. For example, for a layer with a hole, such as the layer shown in FIG. 3 (which is the thirteenth layer for building the part of FIG. 2), two lines are defined with opposite directions. This layer information is used by the additive manufacturing machine to build the part.

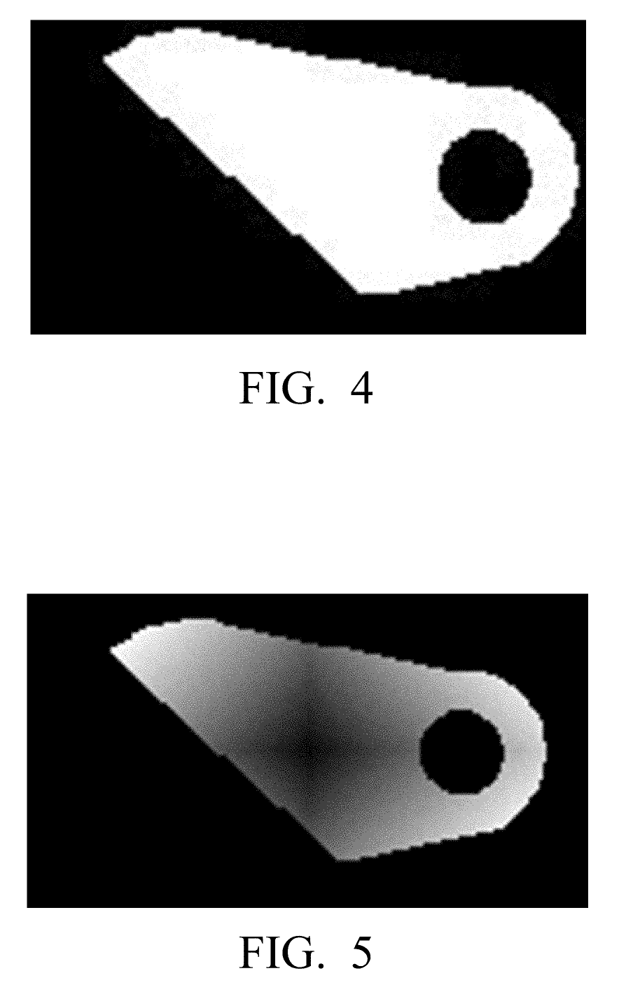

As described above, the next step is creating a template for a 3DQC from the layer information, as indicated by block 110 in FIG. 1. In this example, and referring now to FIG. 1A, for creating the template for the 3DQC, a hatching algorithm converts the CLI description of a layer to a binary layer image with a pixel (hatch) dimension that matches a fundamental dimension of the process, as indicated by block 200. In this case, the pixel dimension is set at 0.100 mm to match the distance between parallel laser scans. FIG. 4 shows the 81×143 pixel binary image corresponding to the layer in FIG. 3. After hatching each layer in the CLI file, a single file, in the Tagged Image File Format (TIFF) or other three-dimensional data format, is created and stores the binary layer images, as indicated by block 202 in FIG. 1A. This binary, three-dimensional image file serves as the template for the 3DQC and is used to index process monitoring data, as further described below.

For further explanation of the step of creating a template for a 3DQC from the layer information, Appendix A includes a Matlab® script for creating a template for the 3DQC from the CLI file. (Matlab® is a registered trademark of The Mathworks Inc. of Natick, Mass.) Of course, the use of such a Matlab® script is but one exemplary method by which the functionality can be implemented. Other programming techniques and languages could be used to code computer-readable instructions onto a computer-readable medium for carrying out this functionality (or any of the other functionality described in the present application), and with benefit of the present description, such programming is readily accomplished by one of ordinary skill in the art.

Now, with respect to the receipt of data and the indexing of that data, as indicated by input 112 and block 114 of FIG. 1, for continuous monitor data, a particular measured value does not change significantly during the scanning of one layer. For example, the build surface temperature may vary by only a few degrees over several hours during the building of a part. So, if the build surface temperature is monitored, a temperature monitor records the current temperature at the beginning of the laser scan for each layer. For this type of monitor, the value at each point in a layer is set to the same value.

FIG. 1B is a flow chart of an exemplary implementation of the step of indexing continuous monitor data (i.e., build surface temperature) to the template. As indicated by input 300 of FIG. 1B, this subroutine commences with the receipt of: (i) a data file (or data stream) that contains the measured build surface (or powder bed) temperature for each layer, which is preferably measured at the beginning of the laser scan for each layer; and (ii) the previously created template for the 3DQC. A file is then created for the build surface temperature data with a data structure that matches the template (i.e., has the same dimensions as the template), as indicated by block 302 of FIG. 1B. The surface build temperature for each discrete layer is then retrieved and read from the data file (or data stream), as indicated by block 304 of FIG. 1B, and then converted into a numerical value, as indicated by block 306 of FIG. 1B. Since, as described above, the surface build temperature is a form of continuous monitor data, and it is assumed that the measured value does not change significantly during the scanning of the layer, the numerical value representative of the surface build temperature is copied into each data field in the file associated with that layer, as indicated by block 308 of FIG. 1B. This subroutine continues until the surface build temperature for the last layer is retrieved and converted, as indicated by decision 310. As described above, the resulting data file is the 3DQC (in the form of a TIFF or other three-dimensional data format of stacked layers) with the same dimensions as the template, as indicated by output 120 in FIGS. 1 and 1B, which is stored as a record of the manufacturing process for the part.

Appendix B includes a Matlab® script that implements the steps of FIG. 1B and creates a 3DQC for build surface temperature data.

For layerwise monitor data, the measured values are different at different points (i.e., two-dimensional locations) within a layer. For example, a thermal camera may record a series of images during the scanning of a layer. These images are processed to determine the peak temperature measured for each pixel in the thermal images of the layer. This processed image (FIG. 5) is stored for each layer. The camera resolution and position generally produces an image (or temperature map) with a different scale, position, and orientation than the template. Thus, indexing of such layerwise monitor data involves registration (or transformation) of the image produced by the camera to the layer coordinate system represented by the template in order to determine the relationship between a pixel value of the image produced by the camera and the three-dimensional location in the template. In this case, the temperature map is 90×160 pixels and is centered differently in the frame, although the orientation is similar. As shown in FIG. 5, the measured peak temperature is lower near the center of the part.

FIG. 1C is a flow chart of an exemplary implementation of the step of indexing layerwise monitor data (i.e., peak temperature) to the template. As indicated by input 400 of FIG. 1C, this subroutine commences with the receipt of: (i) a data file (or data stream) that contains the measured peak temperatures for each point in each layer; and (ii) the previously created template for the 3DQC. A file is then created for the peak temperature data with a data structure that matches the template (i.e., has the same dimensions as the template), as indicated by block 402 of FIG. 1C. The peak temperature for each point in each layer is then retrieved from the data file (or data stream), as indicated by block 404 of FIG. 1C, and then converted into a numerical value, as indicated by block 406 of FIG. 1C.

Referring still to FIG. 1C, the data is then registered to the 3DQC template, as indicated by block 407. Specifically, the 3DQC template is used to register the data file (or data stream) that contains the measured peak temperatures for each point in each layer to the corresponding layer in the sliced part. In other words, the processed image of FIG. 5, which again is an image of the peak temperature measured for each pixel in the thermal images of a layer, is registered to the corresponding layer in the sliced part using the 3DQC template. Such registration step provides several advantages. For instance, such registration adjusts the image data for any distortion that may result from the viewing angle of a particular monitor and its distance from the build surface. Such registration also ensures that data from multiple monitors can be displayed and correlated with each other in a precise way since they all have the same data structure. Finally, such registration may be used to determine the geometric accuracy of the part by measuring deviations between the registered monitor image and the template.

Referring still to FIG. 1C, the numerical values representative of the peak temperatures are then copied into the corresponding data fields, as indicated by block 408 of FIG. 1C. This subroutine continues until the peak temperatures for the data points in the last layer are retrieved and converted, as indicated by decision 410. As described above, the resulting data file is the 3DQC (in the form of a TIFF file or other three-dimensional data format of stacked layers) with the same dimensions as the template, as indicated by output 120 in FIGS. 1 and 1C, which is stored as a record of the manufacturing process for the part.

Appendix C includes a Matlab® script that implements the steps of FIG. 1C and creates a 3DQC for peak temperature data. As reflected in this Matlab® script, in one exemplary implementation, the registration step is achieved primarily through use of the imregister function, which registers an image (such as the image of the peak temperature in FIG. 5) with a reference image (from the 3DQC template).

Thus, the use of a template for the 3DQC ensures that all monitor (continuous or layerwise) data is stored with the same scaling and dimensions, and that such scaling and dimensions are determined by the fundamental dimensions of the part, since the template for the 3DQC is based on the same layer information that is used in the additive manufacturing process.

Also, as should be clear from the above description, the total number of individual 3DQC files for a build will depend on the number of process monitors used.

### Review and Analysis

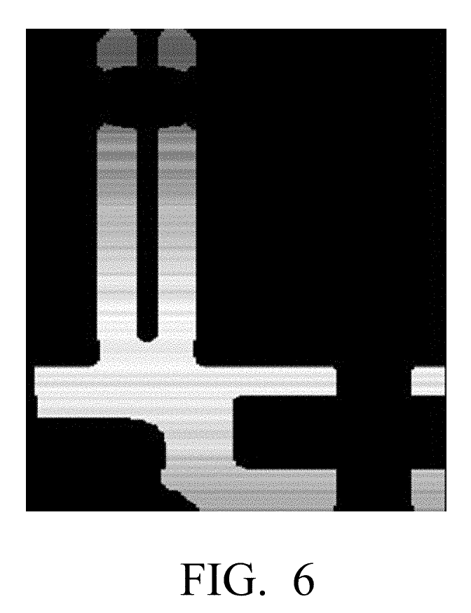

Once a build is completed and all data is converted to the 3DQC format, the results can be viewed and analyzed using any one of several three-dimensional rendering systems that have been developed for viewing and analyzing other three-dimensional data records, such as a computerized topography (CT) or magnetic resonance imaging (MRI) scan data. FIG. 6 is a gray-scale image of build surface temperature for a vertical cut through the part as oriented in FIG. 2. The average temperature during the build period was 166.7° C. There were small layer-to-layer differences and an overall variation of ±1.5° C. The highest build surface temperature was observed approximately one-third of the way through the build, corresponding to the location approximately one-third of the distance from the “bottom” of the part. The lowest build surface temperature occurred near the end of the process, corresponding to the “top” of the part. If the process specification required that the surface build temperature be maintained within the range 165-169° C., then all of the part meets this quality specification. However, if the process specification called for a range of 166-168° C., then the “top” of the part does not meet specification. If this region is critical to the mechanical performance of the part, then this part would be rejected. If this region is not critical to mechanical performance, the part may be accepted with this variance.

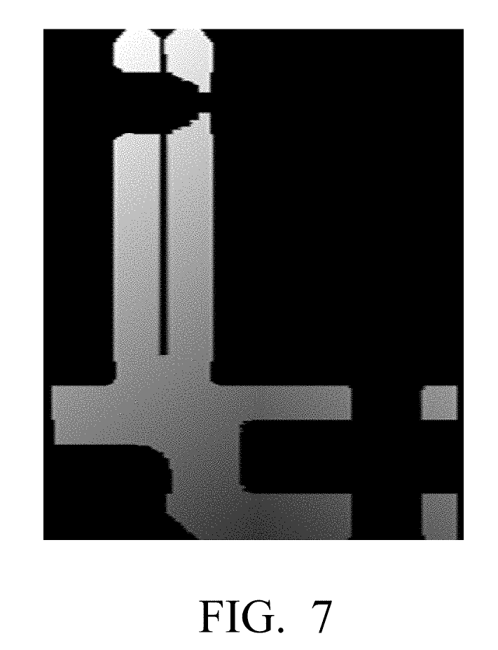

FIG. 7 is a gray-scale image of peak temperature for a vertical cut through the part as oriented in FIG. 2. This gray-scale image shows variation of the peak temperature in both directions, from the center of the part to the edge and from the bottom to the top. If there are regions of the part where the peak temperature was too high or too low, the build surface temperature can be checked for that same region to determine whether this was the cause of the process upset. Also, a CT scan of the part may show regions of low density, and such regions of low density can be compared directly to the process monitor results stored in the 3DQC format.

This method of converting process monitor data to a 3DQC provides a unique and useful quality record for layerwise manufacturing processes. By indexing all collected monitor data to a single template, a template which has been created to match the fundamental dimensions of the build process for the part, correlations between different monitors can be visualized, and process upsets can be related to a particular location in the part. Further, the 3DQC can be used with non-destructive evaluation (NDE) and advanced process control techniques. Post-build part evaluation can also be optimized by focusing on areas where the process monitor results suggest a problem. In advanced process control, the indexing methods used to create the 3DQC may be useful when the optimum process parameters depend on the geometry of the layers and the process history of previous layers.

One of ordinary skill in the art will recognize that additional implementations are also possible without departing from the teachings of the present invention. This detailed description, and particularly the specific details of the exemplary implementations disclosed therein, is given primarily for clarity of understanding, and no unnecessary limitations are to be understood therefrom, for modifications will become obvious to those skilled in the art upon reading this disclosure and may be made without departing from the spirit or scope of the invention.

APPENDIX A
% Open CLI file, count layers and determine range
% Parameters to avoid infinite loops
CLI_filename=‘DraglinkjointA(2)_30micron_p.cli’;

| | |
|---|---|
| maxmod=5; | % maximum number of models (contours) in a layer |
| maxpts=500; | % maximum number of points in contour |
| maxlyr=700; | % maximum number of layers |

pixsize=0.100; % size of each pixel in 3DQC matrix (mm)
% initiate variables for data

| | |
|---|---|
| lyrcnt=0; | % layer counter |
| temp=0; | % temporary variable for values |
| id=0; | % layer id for each model |
| dir=0; | % inside (1) or outside (0) contour |

| | |
|---|---|
| zmin=65535; | % minumum z (layer) value |
| zmax=0; | % maxumum z (layer) value |
| xmin=65535; | % minumum x (layer) value |
| xmax=0; | % maxumum x (layer) value |
| ymin=65535; | % minumum y (layer) value |
| ymax=0; | % maxumum y (layer) value |

```
% Open text file
fid = fopen(CLI_filename,‘r’);
% Read through header
h=textscan(fid,‘%40s’,1);
headerstart=char(h{1,1});% must be $$HEADERSTART
h=textscan(fid,‘%40s’,1);
asci=char(h{1,1}); % should be $$ASCII
h=textscan(fid,‘%40s’,1,‘delimiter’,‘/’);
units=char(h{1,1}); % should be $$UNITS
u=cell2mat(textscan(fid,‘%f’,1)); % Units of CLI file (decimal value)
h=textscan(fid,‘%40s’,1);
string1=char(h{1,1}); % must be $$HEADEREND
h=textscan(fid,‘%40s’,1,‘delimiter’,‘/’);
string2=char(h{1,1}); % must be $$GEOMETRYSTART
% read 1st geometry line
h=textscan(fid,‘%40s’,1,‘delimiter’,‘/’);
string=char(h{1,1}); % must be $$LAYER or $$GEOMETRYEND
% loop through layers
while (lyrcnt<maxlyr)&&(length(string)<11) % not $$GEOMETRYEND
% new layer or new contour within layer?
if length(string)==7
%********************% $$LAYER means start of new layer
    lyrcnt=lyrcnt+1; % increment layer counter
    if lyrcnt<=maxlyr % continue if not too many
    modcnt=0; % start contour (model) counter
    temp=cell2mat(textscan(fid,‘%f’,1)); % z value of layer
    if temp>zmax ; zmax=temp ;end
    if temp<zmin ; zmin=temp ;end
    end
%******************** Done with new layer header
  else
%************ $$POLYLINE means 1st or new contour in layer
    modcnt=modcnt+1; % increment contour counter
% read POLYLINE header data
    id=cell2mat(textscan(fid,‘%u16’,1,‘delimiter’,‘,’));
    dir=cell2mat(textscan(fid,‘%u16’,1,‘delimiter’,‘,’));
    num_pts=cell2mat(textscan(fid,‘%u16’,1,‘delimiter’,‘,’));
% read POLYLINE x,y data
    for i=1:num_pts
      % update maximum and minimum x,y values
      temp=cell2mat(textscan(fid,‘%f’,1,‘delimiter’,‘,’));
      if temp>xmax ; xmax=temp ;end
      if temp<xmin ; xmin=temp ;end
      temp=cell2mat(textscan(fid,‘%f’,1,‘delimiter’,‘,’));
      if temp>ymax ; ymax=temp ;end
      if temp<ymin ; ymin=temp ;end
    end
%************* Done with $$POLYLINE contour data
  end
%************* Done with current contour
% read next line keyword
  h=textscan(fid,‘%40s’,1,‘delimiter’,‘/’);
  string=char(h{1,1});% $$LAYER, $$POLYLINE or $$
  GEOMETRYEND
                  % check using while loop
end % end of geometry while loop
%**************
fclose(fid); % close CLI file
maxlyr=lyrcnt; % number of layers counted above
% create arrays for CLI data
layerz=zeros(maxlyr,1); % layer z value
id=zeros(maxlyr,maxmod,1); % layer id for each model
dir=zeros(maxlyr,maxmod,1); % inside (1) or outside (0) contour
num_pts=zeros(maxlyr,maxmod,1); % no. of pts in each contour
pts=zeros(maxpts,2); % x,y coordinates of a contour
numlayers=lyrcnt;
% scale and offset to convert CLI file coordinates to 3DQC matrix
xmax=xmax+round(pixsize/u); % max/min values of CLI input
coordinates
xmin=xmin−round(pixsize/u);
ymax=ymax+round(pixsize/u);
ymin=ymin−round(pixsize/u);
% number of pixels in layer image. Two extra around edges
maxpix_x=ceil((xmax−xmin)*u/pixsize)+4;
maxpix_y=ceil((ymax−ymin)*u/pixsize)+4;
xscale=(maxpix_x−4)/(xmax−xmin); % scale factor for conversion
yscale=(maxpix_y−4)/(ymax−ymin);
lyrdata=zeros(maxlyr,maxmod,maxpts,2); % store x,y data in single matrix
layer=zeros(maxpix_x,maxpix_y); % working array for layer image
qc=zeros(maxpix_x,maxpix_y,numlayers); % 3D matrix for layer
image data
% Open text file
fid = fopen(CLI_filename,‘r’);
% Read through header
h=textscan(fid,‘%40s’,1);
h=textscan(fid,‘%40s’,1);
h=textscan(fid,‘%40s’,1,‘delimiter’,‘/’);
u=cell2mat(textscan(fid,‘%f’,1)); % Units of CLI file (decimal value)
h=textscan(fid,‘%40s’,1);
h=textscan(fid,‘%40s’,1,‘delimiter’,‘/’);
% loop through layers
lyrcnt=0;
h=textscan(fid,‘%40s’,1,‘delimiter’,‘/’);
string=char(h{1,1}); % $$LAYER, $$POLYLINE or $$
GEOMETRYEND
%***********
while (lyrcnt<=numlayers)&&(length(string)<11) % not
$$GEOMETRYEND
% new layer or new contour?
%**************************
  if length(string)==7 % $$LAYER=new layer
    lyrcnt=lyrcnt+1; % increment layer counter
    if lyrcnt<=numlayers % continue if not too many
% new layer, so reset the model counter and get the layer position
      modcnt=0; % start contour (model) counter
      layerz(lyrcnt,1)=cell2mat(textscan(fid,‘%f’,1)); % z value of layer
    end
  %**************************
  else
% $$POLYLINE=1st or new contour in layer
    modcnt=modcnt+1; % increment contour counter
% read POLYLINE header data
    id(lyrcnt,modcnt)=cell2mat(textscan(fid,‘%u16’,1,‘delimiter’,‘,’));
    dir(lyrcnt,modcnt)=cell2mat(textscan(fid,‘%u16’,1,‘delimiter’,‘,’));
    num_pts(lyrcnt,modcnt)=cell2mat(textscan(fid,‘%u16’,1,
‘delimiter’,‘,’));
% read POLYLINE x,y data
    for i=1:num_pts(lyrcnt,modcnt)
      pts(i,1)=cell2mat(textscan(fid,‘%f’,1,‘delimiter’,‘,’));
      pts(i,2)=cell2mat(textscan(fid,‘%f’,1,‘delimiter’,‘,’));
      lyrdata(lyrcnt,modcnt,i,1)=pts(i,1);
      lyrdata(lyrcnt,modcnt,i,2)=pts(i,2);
    end
%***
% convert line data to layer image coordinates
numpts=num_pts(lyrcnt,modcnt);
layer=zeros(maxpix_x,maxpix_y);
for i=1:numpts
% convert points to layer coordinates
  x=round(xscale*(pts(i,1)−xmin))+2;
  y=round(yscale*(pts(i,2)−ymin))+2;
  layer(x,y)=1; % set pixel to 1
  pts(i,1)=x;
  pts(i,2)=y;
end
% add midpoints until no more new points
maxiter=10;
iter=0;
while iter<maxiter
    iter=iter+1;
newpts=0;
for i=numpts:−1:2
  x=round((pts(i,1)+pts(i−1,1))/2);
  y=round((pts(i,2)+pts(i−1,2))/2);
% distance from endpts
  d=abs(x−pts(i,1))+abs(x−pts(i−1,1))+ ...
      abs(y−pts(i,2))+abs(y−pts(i−1,2));
  if d > 1 % new point
    newpts=newpts+1;
    layer(x,y)=1;
    for j=numpts+newpts:−1:i
        pts(j,1)=pts(j−1,1);
        pts(j,2)=pts(j−1,2);
    end
        pts(i,1)=x;
        pts(i,2)=y;
  end
end
numpts=numpts+newpts;
if newpts==0
    iter=maxiter;
end
end
pts(numpts+1,:)=[0,0];
% grow region (=2) outside of line
% all edges (two pixels) of layer are outside
for j=1:maxpix_y
    layer(1,j)=2;
    layer(2,j)=2;
    layer(maxpix_x−1,j)=2;
    layer(maxpix_x,j)=2;
end
for i=1:maxpix_x
    layer(i,1)=2;
    layer(i,2)=2;
    layer(i,maxpix_y)=2;
    layer(i,maxpix_y−1)=2;
end
% add connected pixels
oldseeds=1;
newseeds=0;
while newseeds ~=oldseeds
    oldseeds=newseeds;
    newseeds=0;
    for i=2:maxpix_x−1
        for j=2:maxpix_y−1
            if layer(i,j)==2
                intens=layer(i−1,j);
                if intens==0;
                    newseeds=newseeds+1;
                    layer(i−1,j)=2;
                end
                intens=layer(i+1,j);
                if intens==0;
                    newseeds=newseeds+1;
                    layer(i+1,j)=2;
                end
                intens=layer(i,j−1);
                if intens==0;
                    newseeds=newseeds+1;
                    layer(i,j−1)=2;
                end
                intens=layer(i,j+1);
                if intens==0;
                    newseeds=newseeds+1;
                    layer(i,j+1)=2;
                end
            end
        end
    end
  end
%************* Done with $$POLYLINE contour
  for i=1:maxpix_x
    for j=1:maxpix_y
        if dir(lyrcnt,modcnt,1)==1 %convert outside to inside
            if layer(i,j)==2
                layer(i,j)=0;
            else
                if layer(i,j)==0
                    layer(i,j)=2;
                end
            end
        end
        if modcnt==1
            qc(i,j,lyrcnt)=layer(i,j);
            inout=dir(lyrcnt,modcnt,1);
        else
            if dir(lyrcnt,modcnt,1)==inout
                qc(i,j,lyrcnt)=qc(i,j,lyrcnt)+layer(i,j);
            else
                qc(i,j,lyrcnt)=qc(i,j,lyrcnt)*layer(i,j);
            end
        end
    end
  end
end
%************* Done with current contour
% read next line keyword
  h=textscan(fid,‘%40s’,1,‘delimiter’,‘/’);
  string=char(h{1,1});% $$LAYER, $$POLYLINE or $$
  GEOMETRYEND
end % end of $$GEOMETRYEND while loop
%**************
% lyrcnt=lyrcnt−1; % Adjust count of layers
for k=1:lyrcnt
  for i=1:maxpix_x
    for j=1:maxpix_y
        test=qc(i,j,k);
        if test>=2
            qc(i,j,k)=1; % must be binary
        else
            qc(i,j,k)=0;
        end
    end
  end
  end
fclose(fid);
save(‘qc.mat’,‘qc’); % save Matlab array
% save as TIFF file
qct=logical(qc);
t = Tiff(‘qct.tif’,‘w’); % create file
t.close( );
for frame=1:lyrcnt
    t = Tiff(‘qct.tif’,‘a’); % open file to append data
    tagstruct.ImageLength = size(qct,1);
    tagstruct.ImageWidth = size(qct,2);
    tagstruct.Photometric = Tiff.Photometric.MinIsBlack;
    tagstruct.BitsPerSample = 1;
    tagstruct.SamplesPerPixel = 1;
    tagstruct.PlanarConfiguration = Tiff.PlanarConfiguration.Chunky;
    tagstruct.Software = ‘MATLAB’;
    t.setTag(tagstruct)
    t.write(qct(:,:,frame));
    t.writeDirectory( );
end
t.close( );
% end of script
```

```
APPENDIX B
%get layerwise constant data
fid=fopen(‘layer_temp.txt’);
layer_data =fscanf(fid,‘%g %g’,[2 inf]);
fclose(fid);
s=size(layer_data);
nlayers=s(2);
% Read template file
qct_lst=imread(‘qct.tif’,‘index’,1);
% get x−y size of template
sz=size(qct_1st);
% create template with right size
qct=uint16(zeros(sz(1),sz(2),nlayers));
qct(:,:,1)=qct_1st; % 1st layer already read
for k=2:nlayers
    qct(:,:,k)=imread(‘qct.tif’,‘index’,k);
end
%create data structure for layerwize constant data
qct_layer=uint16(zeros(sz(1),sz(2),nlayers));
% Index data to 3DQC template
% convert data to 16-bit integer with 0.01 precision
for k=1:nlayers
    qct_layer(:,:,k)=uint16(100*layer_data(2,k));
end
% zero non-part elements
qct_layer=qct.*qct_layer;
% Write tiff image stack with indexed data
t = Tiff(‘3DQC_layer.tif’,‘w’); % create file
t.close( );
for frame=1:nlayers
    t = Tiff(‘3DQC_layer.tif’,‘a’); % open file to append data
    tagstruct.ImageLength = size (qct_layer,1);
    tagstruct.ImageWidth = size(qct_layer,2);
    tagstruct.Photometric = Tiff.Photometric.MinIsBlack;
    tagstruct.BitsPerSample = 16;
    tagstruct.SamplesPerPixel = 1;
    tagstruct.PlanarConfiguration = Tiff.PlanarConfiguration.Chunky;
    tagstruct.Software = ‘MATLAB’;
    t.setTag(tagstruct)
    t.write(qct_layer(:,:,frame));
    t.writeDirectory( );
end
t.close( );
% end of script
```

```
APPENDIX C
%Create 3DQC for layerwise data
%Input x−y data for each layer
load(‘peakT.mat’); % peak temperature data
s=size(peakT);
nlayers=s(3); % number of layers
% Read template file
qct_1st=imread(‘qct.tif’,‘index’,1);
% get x−y size of template
sz=size(qct_1st);
% create template with right size
qct=uint16(zeros(sz(1),sz(2),nlayers));
qct(:,:,1)=qct_1st; % 1st layer already read
for k=2:nlayers
    qct(:,:,k)=imread(‘qct.tif’,‘index’,k);
end
% scale template to data
qct=max(max(max(peakT)))*qct;
%register each layer
[optimizer,metric] = imregconfig(‘monomodal’);
for k=1:nlayers
    img=peakT(:,:,k);
    template=qct(:,:,k);
    registered = imregister(img, template, ‘affine’, optimizer, metric);
qct(:,:,k)=registered;
end
% save as TIFF file
t = Tiff(‘qc_peakT.tif’,‘w’); % create file
t.close( );
for frame=1:nlayers
    t = Tiff(‘qc_peakT.tif’,‘a’); % open file to append data
    tagstruct.ImageLength = size(template,1);
    tagstruct.ImageWidth = size(template,2);
    tagstruct.Photometric = Tiff.Photometric.MinIsBlack;
    tagstruct.BitsPerSample = 16;
    tagstruct.SamplesPerPixel = 1;
    tagstruct.PlanarConfiguration = Tiff.PlanarConfiguration.Chunky;
    tagstruct.Software = ‘MATLAB’;
    t.setTag(tagstruct)
    t.write(qct(:,:,frame));
    t.writeDirectory( );
end
t.close( );
% end of script
```

What is claimed is:

1. A quality certification method for an additive manufacturing process, comprising the steps of:
receiving layer information for a model of a part;
creating a template for a three-dimensional quality certificate based on the layer information;
collecting data using a process monitor during the additive manufacturing process for the part; and
indexing the collected data to the template, thus creating the three-dimensional quality certificate.

2. The quality certification method as recited in claim 1, wherein collected data includes continuous monitor data, which is collected at time intervals and stored with a time-stamp.

3. The quality certification method as recited in claim 1, wherein collected data includes continuous monitor data, which is collected at predetermined time intervals and stored with an indicator of which layer of the part is being built when a particular data point is collected.

4. The quality certification method as recited in claim 1, wherein collected data includes layerwise monitor data that is collected as two-dimensional images of a particular layer of the part during the additive manufacturing process.

5. The quality certification method as recited in claim 1, wherein collected data includes process log data.

6. The quality certification method as recited in claim 1, wherein the step of creating a template comprises:
converting layer information into binary layer images; and
creating a file of the binary layer images.

7. A quality certification method for an additive manufacturing process, comprising the steps of:
receiving layer information for a model of a part;
creating a template for a three-dimensional quality certificate based on the layer information;
receiving data from a continuous process monitor at predetermined time intervals during the additive manufacturing process for the part; and
indexing the received data to the template, thus creating the three-dimensional quality certificate by (i) creating a file with the same data structure as the template, (ii) retrieving data for each discrete layer from the received data, (iii) converting the retrieved data for each discrete layer into a numerical value, and (iv) copying the numerical value into the file.

8. The quality certification method as recited in claim 7, wherein the continuous process monitor records build surface temperatures during the additive manufacturing process for the part.

9. A quality certification method for an additive manufacturing process, comprising the steps of:
receiving layer information for a model of a part;
creating a template for a three-dimensional quality certificate based on the layer information;
receiving data from a layerwise process monitor during the additive manufacturing process for the part; and
indexing the received data to the template, thus creating the three-dimensional quality certificate by (i) creating a file with the same data structure as the template, (ii) retrieving data for each point in each discrete layer from the received data, (iii) registering the retrieved data to the template, (iv) converting the retrieved data for each point in each discrete layer into a numerical value, and (iv) copying the numerical value into the file.

10. The quality certification method as recited in claim 9, wherein the layerwise process monitor records peak temperatures in each discrete layer during the additive manufacturing process for the part.
